(19) United States
(12) Patent Application Publication
(10) Pub. No.: US 2010/0140398 A1
(43) Pub. Date: Jun. 10, 2010

(54) MODULAR GALLEY UNIT INCLUDING BEVERAGE MAKER

(75) Inventors: Craig Cunningham, Old Northants (GB); Mark De Tisi, Pembrey (GB); Peter Burd, Burry Port (GB); Jenny Wilson, Towcester (GB); Sebastien Ramus, Shawnee, KS (US); Geraldine Arnold, Apex, NC (US); Glenn Johnson, Rural Hall, NC (US)

Correspondence Address: ADAMS INTELLECTUAL PROPERTY LAW, Suite 2350 Charlotte Plaza, 201 South College Street, CHARLOTTE, NC, 28244, US

(73) Assignee: BE AEROSPACE, INC., Wellington, FL (US)

(21) Appl. No.: 12/524,345

(22) PCT Filed: Feb. 19, 2008
(86) PCT No.: PCT/US2008/054290

§ 371 Date: Feb. 23, 2010

Related U.S. Application Data
(60) Provisional application No. 60/890,510, filed on Feb. 19, 2007.

(51) Int. Cl. B64D 11/04; A47J 31/00; A47J 31/44

(52) U.S. Cl. 244/118.5; 99/300; 99/288; 99/290

(57) ABSTRACT

A galley unit comprising a plurality of mid-level modules and a plurality of high-level modules that are assembled together to form a modular galley unit, wherein at least one of the mid-level modules is a beverage maker unit. A combination comprising an aircraft and a modular galley unit, wherein at least one of the modules is a beverage maker unit.

### TECHNICAL FIELD AND BACKGROUND OF THE INVENTION

The present invention relates generally to the interior fittings of vehicles, and more specifically, to a modular beverage maker unit for use with a modular galley unit of a passenger vehicle.

Passenger vehicles such as trains, buses, and aircraft typically include one or more galley units for storing and preparing food. These units include features such as storage, refrigeration, heating, and liquid-handling in various combinations. The types and quantity of equipment vary depending on the size and configuration of the vehicle. Currently, liquid handling portions of the galley (i.e., beverage makers or coffee carafes) have a different configuration from other portions of the galley unit, which limits the design flexibility of the galley unit, especially if the galley unit has a modular configuration.

Accordingly, there is a need for a beverage maker which is compatible with a modular galley construction.

Similarly, there is a need for a beverage maker that itself is modular and contains within its structure all necessary elements to function as needed.

### SUMMARY OF THE INVENTION

Therefore, it is an object of the present invention to provide a beverage maker unit adapted for use with a modular galley unit for a passenger vehicle.

It is another object of the invention to provide beverage maker unit that includes within its structure all necessary elements to function as needed.

It is yet another object of the invention to provide a beverage maker that includes a water and power utility connections.

It is a further object of the invention to provide a beverage maker that includes a nozzle for dispensing hot or cold water.

It is a further object of the invention to provide a beverage maker that includes a heating element for heating liquid.

It is a further object of the invention to provide a beverage maker that includes at least one beverage serving container.

It is a further object of the invention to provide a beverage maker unit for a modular galley unit that has exterior dimensions substantially similar to those of other mid-level units. Accordingly, the beverage maker, whether it be an integral unit or a separate module, is adapted to be mounted in the galley unit using the same dimensions and interface points as the other mid-level units.

These and other objects of the present invention are achieved in the preferred embodiments disclosed below by providing a beverage maker unit for a modular galley unit. The beverage maker is contained in a space envelope common to other galley function units.

According to a preferred embodiment, the present invention provides a galley unit comprising a plurality of mid-level modules and a plurality of high-level modules that are assembled together to form a modular galley unit, wherein at least one of the mid-level modules is a beverage maker unit.

### BRIEF DESCRIPTION OF THE DRAWINGS

The invention may be best understood by reference to the following description taken in conjunction with the accompanying drawing figures in which:

FIG. 1 is a perspective view of a galley unit constructed including a beverage maker according to one aspect of the invention;

FIG. 2 is a front view of a mounting structure which connects to the beverage maker of FIG. 1;

FIG. 3 is a perspective view of a galley unit including a beverage maker according to another embodiment of the invention;

FIG. 4 is a perspective view of the beverage maker shown in FIG. 3 with one of the carafe trays extended from the galley unit housing; and

FIG. 5 is a perspective view of the beverage maker shown in FIG. 3 with the filter tray extended from the galley unit housing;

### DESCRIPTION OF THE PREFERRED EMBODIMENT AND BEST MODE

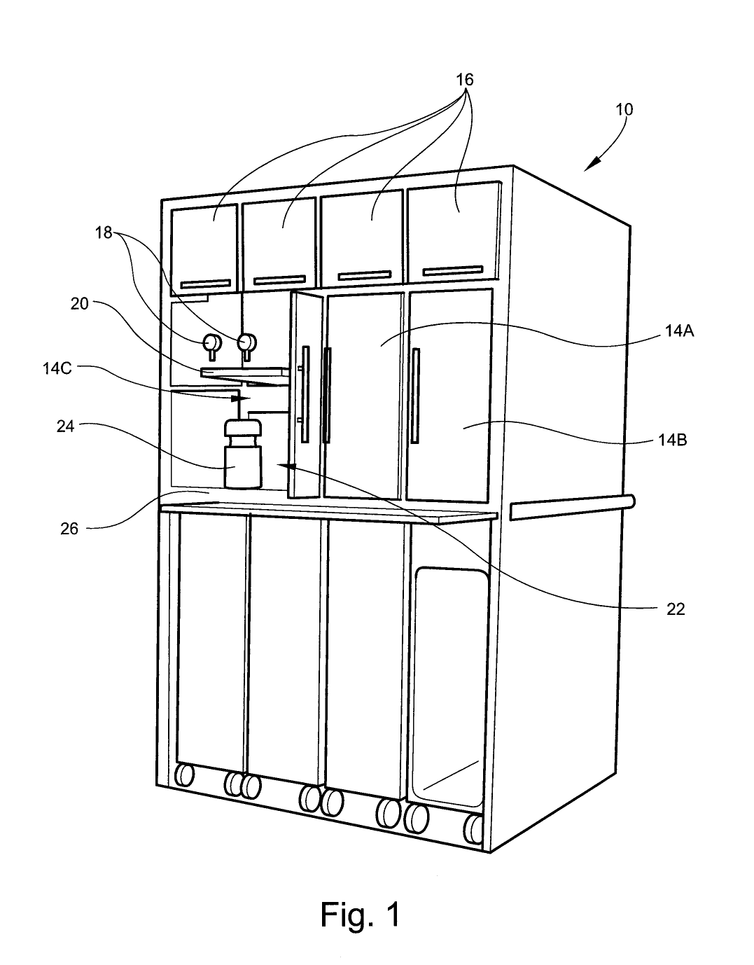

Referring now specifically to the drawings, wherein identical reference numerals denote the same elements throughout the various views, an exemplary galley unit 10 constructed according to the present invention is illustrated in FIG. 1. The galley unit 10 includes a plurality of sub-units that may be constructed as integral parts of the galley unit 10, or built-up from a selection of modules. In the illustrated example, the galley unit 10 includes a plurality of mid-level units 14A-C, and a plurality of high-mounted units 16 that are assembled together to form a modular galley unit. The mid-level units 14A-C are positioned at a convenient working height, and thus would typically include some functional features. For example, unit 14A may be an oven which includes heating elements and temperature controls for reheating packaged meals, and unit 14B may be a refrigerator which includes a cooling system for storing chilled foods at a predetermined temperature. The high-mounted units 16 may be used as storage compartments for foods, condiments, utensils, or the like. A plurality of wheeled carts are preferably stowed beneath the mid-level units and include casters.

One of the mid-level sub-units is beverage maker 14C. The beverage maker includes water dispenser nozzles 18, for dispensing hot, cold, or room-temperature water or other liquid, as well as water heating and/or cooling equipment of a known type (not shown) operatively connected to the nozzles 16. A slide-out tray 20, optionally having a drainage provision, can be provided under the nozzles for supporting items or for capturing drips. A compartment 22 is sized and shaped to store one or more beverage serving containers, such as a carafe 24, and may include conventional brewing equipment for coffee, tea, or other hot beverages. A slide-out tray 26, optionally having a drainage provision, can be provided about the base of the beverage maker unit for supporting the carafe 24, and may include heating elements or a heating pad for maintaining a desired temperature of the contents of the carafe 24.

The exterior dimensions of the beverage maker 14C are substantially similar or the same as the other mid-level units 14. Accordingly, the beverage maker 14C, whether it be an integral unit or a separate module, can be mounted in the galley unit 10 using the same dimensions and interface points as the other mid-level units 14. The beverage maker is thus a modular unit that may be a component of a modular galley unit or may also function as a stand-alone unit. The beverage maker 14C may be replaced by other mid-level units, such as 14A and 14B, and the other mid-level units such as 14A and 14B may be replaced with another beverage maker 14B to expand capacity.

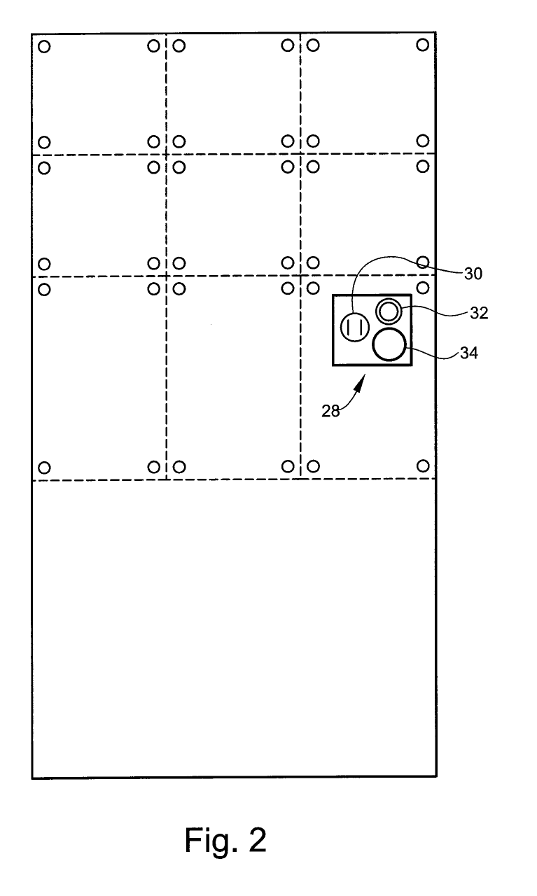

The galley unit 10 or another structure to which the beverage maker 14C is mounted may include utility connections 28 (see FIG. 2) for the beverage maker 14C, such as an electrical power connector 30, a potable water supply connector 32, and a waste water drain 34. The utility connections 28 are configured with known types of quick-connect fittings that mate with complementary fittings of the module (not shown) as the beverage maker 14C is pushed into place in the galley unit 10.

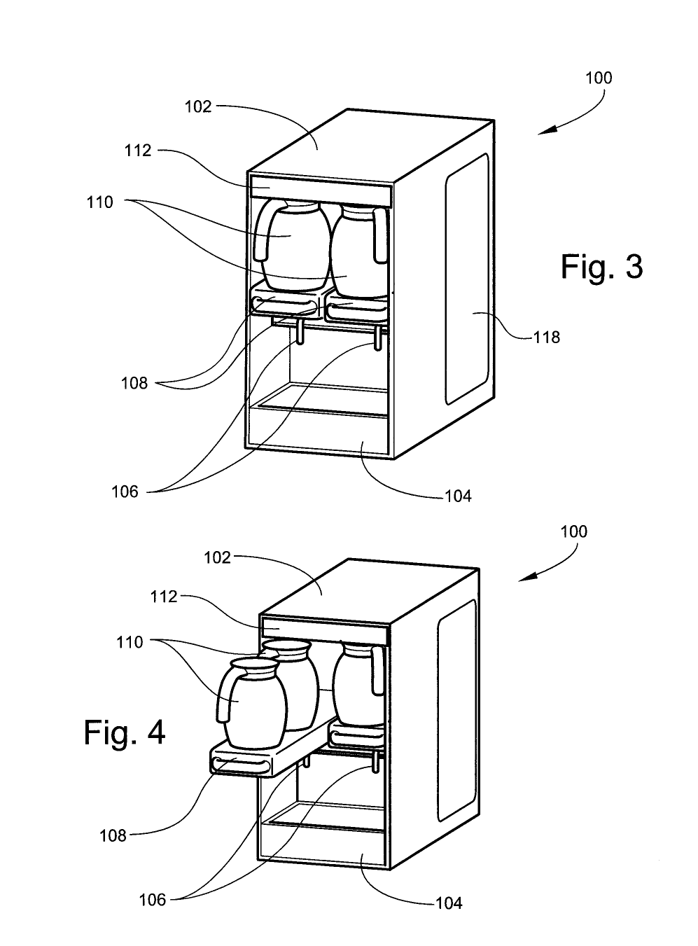

Referring now to FIGS. 3, 4 and 5, an alternative embodiment of a beverage maker is shown at broad reference numeral 100. As with the other embodiments disclosed, the beverage maker 100 includes a housing 102 sized and arranged to slide into and interface with various utility connections. See FIG. 2. Beverage maker 100 includes a sink 104 positioned beneath hot and cold water supply spigots 106 and a pair of slide-out carafe trays 108 that support beverage carafes 110. The carafe trays 108 contain heating elements that maintain desired beverage temperature in the carafes 110, and are adapted to slide out far enough to allow ready access to the rear carafes 110. The sink 104 functions to catch drips or splashes from the carafes 110 positioned on the carafe trays 108, as well as water from the water spigots 106.

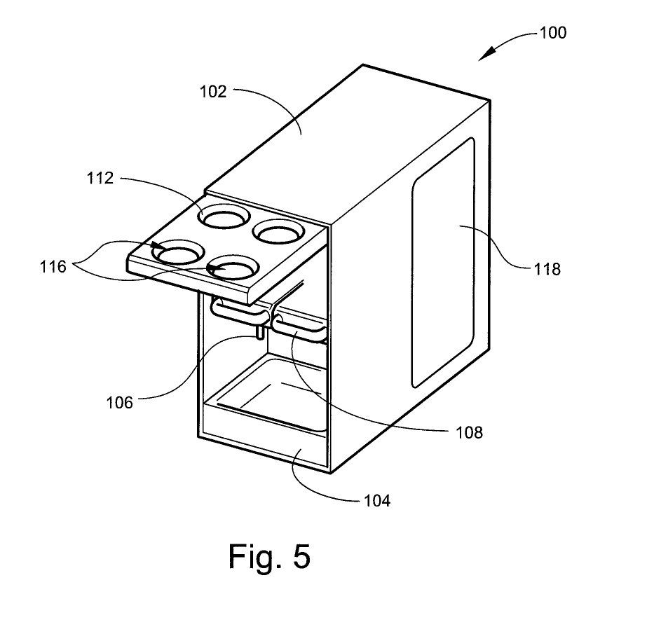

As is best shown in FIG. 5, the beverage maker 100 also includes a slide-out filter tray 112 that includes filter openings 116 to receive coffee filters for brewing coffee and allowing the brewed coffee to drip into the carafes 110 positioned directly below on the trays 108. Water supplied from a tank 118, shown schematically, is conveyed to a position above the filter tray 112 and dispensed onto the filter openings 116. When brewing coffee, the filter 112 is slid out and loaded with filters containing coffee grounds, slid back into position over the carafes 110, as shown in FIGS. 3 and 4, and the brewing process initiated at a control panel, not shown.

The modular galley unit is preferably installed within an aircraft, train, bus or any other vehicle including a passenger compartment and a passenger servicing compartment.

A galley unit with a beverage maker is described above. Various details of the invention may be changed without departing from its scope. Furthermore, the foregoing description of the preferred embodiment the invention and the best mode for practicing the invention are provided for the purpose of illustration only and not for the purpose of limitation.

What is claimed is:

1. A galley unit comprising a plurality of mid-level modules and a plurality of high-level modules that are assembled together to form a modular galley unit, wherein at least one of the mid-level modules is a beverage maker unit.

2. The galley unit according to claim 1, wherein the galley unit includes an electrical utility connection and a water supply utility connection, and the beverage maker unit connects to electrical utility connection and the water supply connection of the galley unit.

3. The galley unit according to claim 1, wherein the beverage maker unit includes at least one nozzle for dispensing a liquid.

4. The galley unit according to claim 1, wherein the beverage maker unit includes at least one carafe tray, at least one carafe, at least one filter tray and at least one heating pad for heating the at least one carafe.

5. The galley unit according to claim 1, wherein the beverage maker unit includes a sink and a waste water drain.

6. The galley unit according to claim 1, wherein the beverage maker unit includes a water supply tank.

7. The galley unit according to claim 1, wherein the beverage maker unit defines a compartment for storing at least one carafe therein.

8. A combination, comprising:
an aircraft including a passenger servicing compartment; and
a modular galley unit installed within the passenger servicing compartment, the modular galley unit including a plurality of mid-level modules and a plurality of high-level modules that are assembled together to form the modular galley unit, wherein at least one of the mid-level modules is a beverage maker unit.

9. The combination according to claim 8, wherein the galley unit includes an electrical utility connection and a water supply connection for connecting the beverage maker unit thereto.

10. The galley unit according to claim 8, wherein the beverage maker unit includes a nozzle for dispensing a liquid, a carafe, a carafe tray, a filter tray, a coffee maker, a heating pad, a sink, a waste water drain, and a compartment for storing the carafe therein.
